(19) United States
(12) Patent Application Publication
(10) Pub. No.: US 2006/0102139 A1
(43) Pub. Date: May 18, 2006

(54) Rotary internal combustion engine

(76) Inventor: Balbino Fernandez Garcia, Mardrid (ES)

Correspondence Address: Striker Striker & Stenby, 103 East Neck Road, Huntington, NY, 11743, US

(21) Appl. No.: 10/521,051

(22) PCT Filed: Jul. 15, 2003
(86) PCT No.: PCT/ES03/00369

§ 371 Date: Sep. 13, 2005

(30) Foreign Application Priority Data
Jul. 19, 2002 (ES) P200201707

(51) Int. Cl. F02B 53/00; F02B 75/00

(52) U.S. Cl. 123/200

(57) ABSTRACT

The invention relates to a rotary internal combustion engine. More specifically, the invention relates to a coaxial stator (1) and rotor (7). The stator (1) is provided with an inlet nozzle (19) and an exhaust nozzle (20) while the rotor is provided with radial mobile blades (9) which are disposed in grooves (8) with room to move. According to the invention, the inner tips of the aforementioned blades (9) are provided with shafts (15) and a pair of connecting rods (16) is articulated to each of said shafts (15). In this way, at each of the ends of the engine, four connecting rods (16) form a deformable parallelogram which connects four alternating blades (9), while another four connecting rods form a second parallelogram which connects the other four blades. As a result, a mechanical transmission system is created between the blades (9) which ensures that the retraction movements of any of said blades are transmitted to the remaining blades of the group, so that the segments (11) disposed at the free edge thereof are permanently in contact with the inner surface (19) of the stator (1), thereby ensuring that the chambers (18) defined by the blades between the stator (1) and the rotor (7) are perfectly sealed.

### OBJECT OF THE INVENTION

The present invention relates to an either explosion or internal combustion engine that, maintaining the functional features of reciprocating piston engines, that is, dividing its work cycle in four times, intake, compression, explosion, combustion and exhaust, achieves this operative cycle by means of a rotary work system, which considerably improves its functional features, setting a considerably greater output and, consequently, a greater power harnessing, allowing a much greater rating due to an explosion each 45° of rotation; which is equivalent to eight useful times each 360° and a significant reduction in manufacturing costs, volume, weight, number of parts, and maintenance costs due to breakdowns.

This means better use of its power, as the explosion time thrust is completely tangential to the rotor diameter, as well as the increase of the surface of the pushing blade in the explosion chamber as it advances in its circular displacement.

With this successive chamber system, no electrical o mechanical equipment is necessary for producing the explosion or combustion, simply by communicating the explosion chamber with the immediate chamber to explode by means of a slot machined in the side covers to the rotational degrees in which we desire the next explosion time to occur.

### BACKGROUND OF THE INVENTION

Explosion or internal combustion rotary engines with the aforementioned four times are known in which a rotor rotates inside a stator, both coaxially assembled, such that while the rotor is cylindrical, the stator has an irregular contour, defining chambers of different width with the rotor, which are made independent from each other in collaboration with floating blades projecting radially from rotor housings and which tend to press on the stator wall by centrifugal force, properly making the mobile chambers, which are generated on the engine perimeter and which correspond to said intake, compression, explosion, and exhaust stages, independent from each other.

In this sense it is worth mentioning, among others, Spanish patent with application number P9700883.

This solution, absolutely valid from a theoretical standpoint, has in practice tightness problems making this type of motors unfeasible.

Such tightness problems are specifically derived from the floating nature of the blades, since if a perfect fit between them, the rotor, and the stator is set, mobility problems are generated, and if they are provided with the necessary play so that said mobility is completely satisfactory, tightness is lost and communication between chambers occurs, drastically reducing the output of the engine, even making it inefficient.

### DESCRIPTION OF THE INVENTION

The rotary engine proposed by the invention, starting from the basic generality of using a coaxial rotor and stator, solves in a completely satisfactory way the problems set forth above, ensuring a perfect mobility for the blades, as well as an also perfect tightness between chambers defined by said blades.

More particularly, the stator is carried out in a tubular block of elliptical section, with the typical intake and exhaust nozzles and the also typical cooling conduits inside of it, tubular block that is closed by means of a pair of end covers screwed thereto with the placing in-between of respective gaskets, covers incorporating the bearings or rotation means for the rotor, which is cylindrical, has a diameter coincident with the minor axis of the ellipse corresponding to the stator and includes eight radial blades that play in eight other housings, but the special characteristic that each one of said blades includes in its inner extremity a shaft and such that between the eight shafts corresponding to the eight blades there are set sixteen articulated connecting rods, eight on each side of the engine, hingedly joined by connecting alternate blades, such that four of said blades are connected to each other by means of four articulated connecting rods on each end configuring two articulated parallelograms, while the other four blades are also connected to each other at each end of the engine by means of four articulated connecting rods determining a second pair of articulated parallelograms.

Thereby and by means of an adequate sizing of said articulated connecting rods, these force the blades to be in permanent contact with the inner surface of the stator, that is with the jacket, without the centrifugal force having to act in order to do so, said blades losing the typical floating nature, and being impossible under any circumstances, that is under any type of stress, that any of said blades may separate at any time from the stator wall.

In accordance with another of the invention features, it has been provided for each one of said blades to have its outer edge grooved in the shape of a channel for the emplacement of a segment of complementary configuration, such that said segments may freely swing with respect to the corresponding blades in order to achieve at all times a perfect emplacement thereof on top of the stator wall regardless of the degree of tilt that the blades adopt with respect to said wall.

Segments of rectangular section set on both the blade faces and the minor edges or ends thereof ensure tightness both in their housings in the rotor and with respect to the end covers or walls of the chambers defined in-between the rotor and stator.

### DESCRIPTION OF THE DRAWINGS

To complement the description being made and for the purpose of aiding to better understand the features of the invention, in accordance with a preferred practical embodiment thereof, a set of drawings is attached as an integral part of said description, wherein with an illustrative and non-limiting nature, the following has been shown:

FIG. 1 shows a schematic perspective view of the rotor participating in the explosion or internal combustion rotary engine object of the present invention.

FIG. 2 shows also in perspective view of one of the blades collaborating with the rotor of the previous figure.

FIG. 3 shows a perspective view of a detail of one of the articulated connecting rods connecting the rotor blades.

FIG. 4 shows a perspective view of a detail of the stator complementary to the rotor of FIG. 1.

FIG. 5 shows a perspective view of one of the covers closing the stator of the previous figure.

FIG. 6 lastly shows a cross sectional view of a detail of the engine as a whole at the level of the intake and exhaust ports.

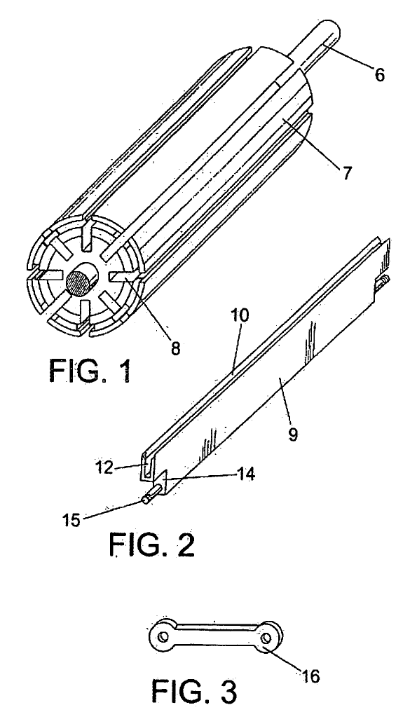

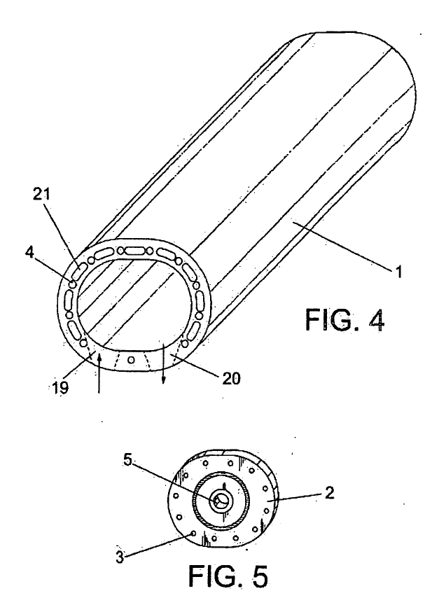

### PREFERRED EMBODIMENT OF THE INVENTION

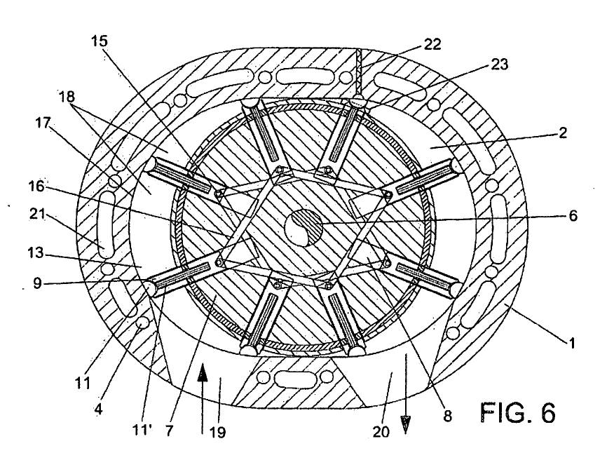

In view of the indicated figures, it can be seen how the rotary engine proposed by the invention is made up of a tubular stator (1) which externally can adopt any configuration but that internally has an elliptical section, tubular body which is closed by means of a pair of end covers (2) fixable in collaboration with through screws through holes (3) of the covers and which thread in holes (4) of the body (1), the covers (2) having a central hole (5) for passage of the shaft (6) of the rotor (7), rotor which is essentially cylindrical and which has a plurality of radial grooves (8) which affect it in its entire length, namely in a number of eight, intended for receiving respective blades (9), basically rectangular, with their free and longitudinal edge (10) grooved for receiving a sealing segment (11) of section approximately of a circular segment, as specially seen in FIG. 6, longitudinal groove (10) which is ended at the ends of the blade (9) in transversal grooves (12) of rectangular section for coupling, and other segments which in this case act on the covers (2) of the stator, whereupon the chambers (13) formed by said blades (9) between the rotor and stator are perfectly sealed.

In accordance with the essentiality of the invention, the blades (9) include stepped recesses (14) in their inner apexes in which respective coaxial shafts (15) are located, intended for hingedly receiving articulated connecting rods (16) such as the one shown in detail in FIG. 3, such that these articulated connecting rods (16) are associated in pairs to each shaft (15), each articulated connecting rod (16) extending, and in each one of the ends of the engine, between two non-adjacent blades (9), namely separated by an intermediate blade, such that in each rotor end and as seen in FIG. 6, four articulated connecting rods (16) make up a deformable parallelogram connecting four blades (9), and the other four articulated connecting rods (16) configure a second deformable parallelogram connecting for its part the other four blades (9) arranged alternately with the previous ones.

Thereby and by means of an adequate sizing of said articulated connecting rods (16), it is achieved that these act as spacers for the blades (9), such that each group of four articulated connecting rods or rather each pair of groups of four articulated connecting rods located on both ends of the engine forces the corresponding four blades (9) to be in permanent contact with the inner face (17) of the stator (1), jointly ensuring with segments (11) and (11′) a perfect tightness for the chambers (18) that said blades (9) configure between the stator (1) and rotor (7).

In all other respects and as is conventional, the stator (1) will have the typical intake (9) and exhaust (20) nozzles, as well as the typical pipes (21) for cooling water circulation, and the stator (1) will also have water circulation conduits properly communicated with manifolds set at the ends of its shaft.

In accordance with another of the features of the invention, it has been provided for that, at the level of the housing (22) of the stator (1) for the spark plug, small recesses (23) are set in the covers (2) making that at the moment in which each blade (9) passes by said housing (22) of the spark plug, the recesses (23) set a certain communication between the immediately preceding and subsequent chambers of said blade (9), which substantially improves ignition.

Thereby, a motor is obtained the rotor and stator of which generate by their own mobility, in collaboration with the blades (9), the chambers corresponding to different cycles without the need of valves, cam shafts or other accessories, with an output that can amount to in the order of four times greater than that of classic reciprocating engines, with an extraordinary structural simplicity that has an impact at both the cost level and the breakdown level, a 20 to 1 compression ratio being achieved, more than enough for working in both combustion engines and explosion engines.

1. An explosion or internal combustion rotary engine, of the type structured by means of a cylindrical rotor with radial housings for a plurality of blades defining chambers in a tubular stator, of generally cylindrical inner configuration, which is closed by means of end covers, characterized in that the stator (1) includes an inner wall (17) of elliptical section, while the rotor (7) includes eight radial blades (9) properly interrelated such that the retraction movement of part of them is combined with the ejection movement of the others in order for the mechanical relationship existing between them to determine that the same are kept in permanent contact with the inner wall (17) of the stator (1).

2. An explosion or internal combustion rotary engine according to claim 1, characterized in that said blades (9) include, in correspondence with their lower apexes, respective shafts (15) to which pairs of articulated connecting rods (16) are hingedly joined, with the special characteristic that four articulated connecting rods (16) are hingedly joined to four blades (9) at each end of the engine, configuring an articulated parallelogram, while another four blades (9) are hingedly joined to the other four blades, configuring a second articulated parallelogram, and such that these two parallelograms are angularly offset, each one of them affecting four blades in alternate arrangement with respect to the other four.

3. An explosion or internal combustion rotary engine according to previous claims, characterized in that each blade (9) includes its recessed outer edge (10), configuring a groove as a channel in which a segment (11) is coupled with freedom of movement, which constitutes a bridge of union between the blade (9) and the wall (17) of the stator (1) and which adopts a configuration as an approximately cylindrical segment, each segment (11) overlapping on its ends another two segments (11′) coupled in rectangular channels (12) of the ends of the blade (9).

4. An explosion or internal combustion rotary engine according to previous claims, characterized in that said articulated connecting rods (16) are located in a pair of chambers established between the ends of rotor (7) and the covers (2) closing the tubular body (1) constituting the stator.

5. An explosion or internal combustion rotary engine according to previous claims, characterized in that its covers (2) each include, at the level of the housing (22) of the stator for the spark plug, small recesses (23) communicating the chambers adjacent to each blade (9) when the latter passes by the spark plug.
